(19) United States
(12) Patent Application Publication
(10) Pub. No.: US 2010/0123940 A1
(43) Pub. Date: May 20, 2010

(54) IMAGE FORMING APPARATUS AND IMAGE FORMING METHOD

(75) Inventor: Yoshikatsu Kamisuwa, Tokyo-to (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/619,741

(22) Filed: Nov. 17, 2009

Related U.S. Application Data
(60) Provisional application No. 61/115,218, filed on Nov. 17, 2008.

(51) Int. Cl. H04N 1/387; G03G 15/00

(52) U.S. Cl. 358/452; 399/364

(57) ABSTRACT

An image forming apparatus includes a reading unit which reads a document image, a detecting unit which detects a document direction representing whether a sub-scanning direction in reading the document image is a short side or a long side direction of an original document, a designating unit which designates, as a copying function, a form for copying the document image on a sheet, an editing unit which edits the read document image as an image corresponding to the designated copying function, a copying unit which copy the edited image on the sheet, and an acquiring unit which acquires a sheet direction representing whether a conveying direction of the sheet conveyed to the copying unit is the short side or the long side direction of the sheet. The editing unit executes processing on the document image on the basis of the document direction, the sheet direction, and the designated copying function.

### CROSS REFERENCE TO RELATED APPLICATION

This application is based upon and claims the benefit of U.S. Provisional Application No. 61/115,218, filed on Nov. 17, 2008.

### TECHNICAL FIELD

Described herein relates to an image forming apparatus and an image forming method, and, more particularly to an image forming apparatus and an image forming method with which a user can correctly process duplex printing, stapling, and 2-in-1 printing without performing complicated designation of a direction in which an original document is placed and a direction of a sentence.

### BACKGROUND

As a method for a user to realize intended stapling using an image forming apparatus, there is known a technique with which the user designates a combination of a direction of an original document and a direction of a sentence (JP-A-2003-145879).

In the technique disclosed in JP-A-2003-145879, the user designates a document direction and a sentence direction and selects a pattern of stapling that can be realized in the designated document direction and sentence direction. Therefore, the user needs to understand what a screen for selecting directions of an original document and a sentence to be displayed and a pattern screen for realizable stapling mean.

### SUMMARY

Described herein relates to an image forming apparatus including: an image reading unit configured to read a document image; a document-direction detecting unit configured to detect a document direction representing whether a sub-scanning direction in reading the document image is a short side direction or a long side direction of an original document; a copying-function designating unit configured to designate, as a copying function, a form for copying the document image on a sheet; an editing unit configured to edit the read document image as an image corresponding to the designated copying function; a copying unit configured to copy the edited image on the sheet; and a sheet-direction acquiring unit configured to acquire a sheet direction representing whether a conveying direction of the sheet conveyed to the copying unit to copy the image is the short side direction or the long side direction of the sheet, wherein the editing unit executes processing including rotation or reduction on the document image on the basis of the document direction, the sheet direction, and the designated copying function.

Described herein relates to an image forming apparatus including: an image reading unit configured to read a document image; a sentence-direction detecting unit configured to detect a sentence direction indicating whether an original document is a portrait document or a landscape document; a document-direction detecting unit configured to detect a document direction representing whether a sub-scanning direction in reading the document image is a short side direction or a long side direction of the original document; a copying-function designating unit configured to designate, as a copying function, a form for copying the document image on a sheet and collectively finishing plural sheets; an editing unit configured to edit the read document image as an image corresponding to the designated copying function; a copying unit configured to copy the edited image on the sheet; a sheet-direction acquiring unit configured to acquire a sheet direction representing whether a conveying direction of the sheet conveyed to the copying unit to copy the image is the short side direction or the long side direction of the sheet; and an output unit configured to convey the copied sheet to a finishing unit to finish the sheet, wherein the editing unit executes processing including rotation on the document image on the basis of the sentence direction, the document direction, the sheet direction, and the designated copying function.

Described herein relates to an image forming apparatus including: an image reading unit configured to read a document image; a sentence-direction detecting unit configured to detect a sentence direction indicating whether an original document is a portrait document or a landscape document; a document-direction detecting unit configured to detect a document direction representing whether a sub-scanning direction in reading the document image is a short side direction or a long side direction of the original document; a copying-function designating unit configured to designate, as a copying function, a form for copying the document image on a sheet and a form for collectively finishing copied plural sheets; an editing unit configured to edit the read document image as an image corresponding to the designated copying function; a copying unit configured to copy the edited image on the sheet; a sheet-direction acquiring unit configured to acquire a sheet direction representing whether a conveying direction of the sheet conveyed to the copying unit to copy the image is the short side direction or the long side direction of the sheet; and an output unit configured to convey the copied sheet to a finishing unit to finish the sheet, wherein the editing unit executes processing including rotation or reduction on the document image on the basis of the sentence direction, the document direction, the sheet direction, and the designated copying function.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of a schematic configuration of an image forming apparatus;

FIG. 2 is a diagram of a control panel of an MFP;

FIG. 3 is diagram of a setting screen example of a display unit;

FIGS. 4A to 4D are diagrams of directions of original documents and directions of sentences designated by a user when the user sets the original documents on a document table;

FIGS. 5A to 5H are diagrams of directions of original documents for stapling with respect to combinations of sentence directions, document directions, and sheet directions;

FIGS. 6A to 6H are diagrams of directions of original documents for duplex printing with respect to combinations of sentence directions, document directions, and sheet directions;

FIGS. 7A to 7H are diagrams of directions of original documents for 2-in-1 printing with respect to combinations of sentence directions, document directions, and sheet directions;

FIG. 8 is a diagram of blocks for controlling image forming operation of an image forming apparatus according to an embodiment of the present invention; and

FIG. 9 is a flowchart of schematic copying operation in the image forming apparatus according to the embodiment.

### DETAILED DESCRIPTION

An image forming apparatus according to an embodiment of the present invention is explained below with an MFP (Multi Function Peripheral) 100 as an example.

The MFP 100 is a digital multi function peripheral for comprehensively utilizing functions of various kinds of office equipment. The MFP 100 has not only a function of scanning, reading, and copying an image at designated resolution and sheet size but also various functions such as an image transmitting and receiving function by facsimile, an image transmitting and receiving function by email, and a printed image transmitting and receiving function via a network.

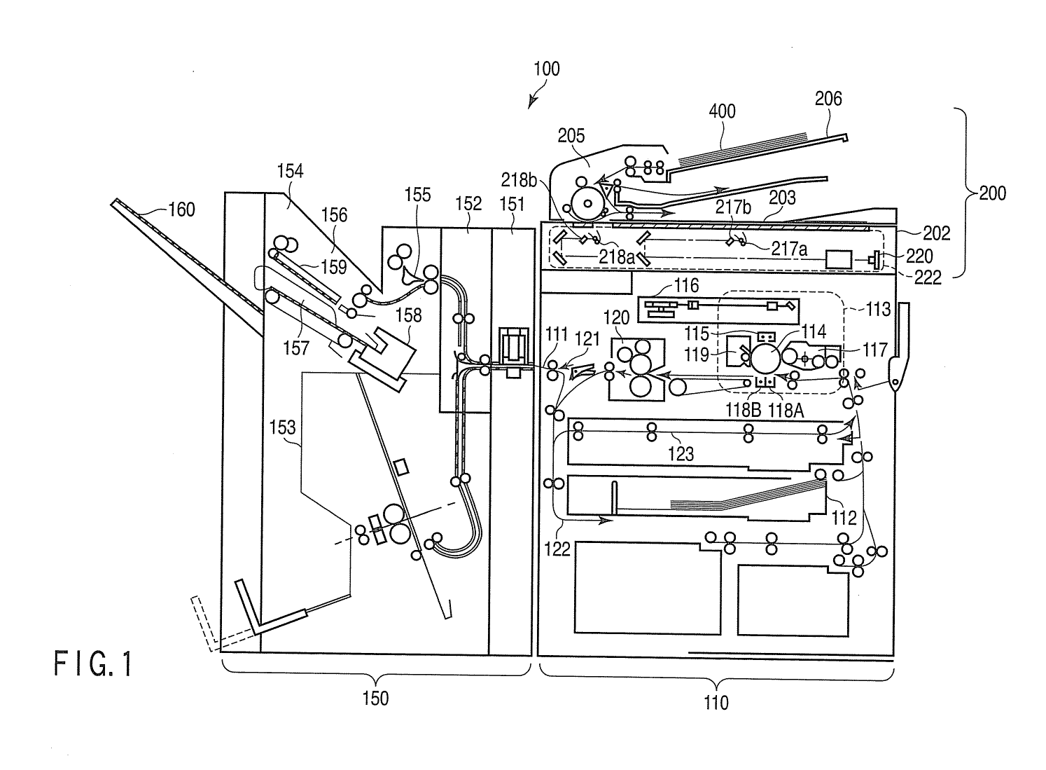

FIG. 1 is a sectional view of a schematic configuration of the MFP 100. The MFP 100 includes an image forming apparatus main body 110, a sheet post-processing apparatus 150, and an image reading apparatus 200.

The image reading apparatus 200 includes a main body housing 202, a document table 203, and a document feeder 205. The document table 203 is set in an upper part of the main body housing 202. A document feeder 205 is set on the document table 203. The document feeder 205 feeds an original document to the document table 203 and also functions as a document pressing plate that presses the original document to set the original document in close contact with the document table 203. The document feeder 205 is openable and closable.

The main body housing 202 includes an exposing and scanning optical system 222 including a first traveling member 217, a second traveling member 218, a lens 219, and an image reading unit 220. The first traveling member 217 is mounted with a light source 217a and a mirror 217b. The second traveling member 218 is mounted with a mirror 218a and a mirror 218b.

The operation of the exposing and scanning optical system 222 in reading an original document placed on the document table 203 is explained. The first traveling member 217 and the second traveling member 218 move in a left-to-right direction (a sub-scanning direction) of the figure. The light source 217a on the first traveling member 217 irradiates light on the original document placed on the document table 203. The light reflected by the original document is sequentially reflected by the mirror 217b on the first traveling member 217 and the mirrors 218a and 218b on the second traveling member 218 and made incident on the lens 219.

The lens 219 condenses the incident light from the second traveling member 218 and irradiates the light on the image reading unit 220. The image reading unit 220 includes a CCD (Charge Coupled Device) as a photoelectric conversion element and an image processing unit. The image processing unit executes processing such as shading correction on an electric signal photoelectrically converted by the CCD and outputs image data (an image signal).

When an original document 400 is placed on a document tray 206 of the document feeder 205, the first traveling member 217 and the second traveling member 218 maintain a state in which the traveling members are stopped in predetermined reading positions. When the document 400 is conveyed on the document table 203 and passes over the reading positions, an image of the document 400 is read. Since operation after this is the same as the operation explained above, detailed explanation of the operation is omitted.

The image forming apparatus main body 110 can form a monochrome image and a color image. The image forming apparatus main body 110 includes a sheet storing unit 112 that stores sheets and an image forming unit 113 that forms an image on a sheet.

The image forming unit 113 includes a rotating transfer drum unit 114. A charging unit 115, an image exposing unit 116, a developing unit 117, a transfer unit 118A, a charge removing unit 118B, and a cleaning unit 119 are arranged around the transfer drum unit 114.

The operation of the image forming unit 113 is explained below.

The charging unit 115 charges the surface of the transfer drum unit 114. The image exposing unit 116 exposes and scans the surface of the transfer drum unit 114 with a laser on the basis of image data sent from the image reading apparatus 200 or image data transmitted via facsimile, email, or a network. The developing unit 117 forms a reversely-developed toner image on the surface of the transfer drum unit 114.

A sheet fed from the sheet storing unit 112 is conveyed to a transfer position of the image forming unit 113. The transfer unit 118A transfers the toner image onto the sheet. The charge removing unit 118B removes charges of the sheet. A fixing unit 120 fixes the toner image on the sheet with heat and pressure. A paper discharge unit 111 discharges the sheet to the sheet post-processing apparatus 150. The cleaning unit 119 removes a toner remaining on the surface of the transfer drum unit 114. Consequently, the image forming unit 113 is prepared for the next image forming processing.

The operation of duplex printing is explained.

Duplex printing in the image forming apparatus main body 110 is designated by an input instruction through an operation panel by a user or a print instruction from an external apparatus such as a PC connected to the MFP 100 via a LAN. When the duplex printing is instructed, the sheet having the toner image transferred thereon and discharged from the fixing unit 120 is sent to a reversal path 122 by a branching member 121. A traveling direction of the sheet is reversed and the front and rear of the sheet are reversed in the reversal path 122. The reversed sheet is conveyed to a duplex conveying path 123 and guided to the image forming unit 113 again. An image is formed on the rear side of the sheet in an image forming process same as that for the front side. The sheet having the images formed on both the front and rear sides hereof is discharged from the paper discharge unit 111 and carried into the sheet post-processing apparatus 150.

The sheet post-processing apparatus 150 includes a puncher unit 151, a sheet separating unit 152, a second post-processing unit 153, and a first post-processing unit 154. The puncher unit 151 performs post-processing such as punching. The sheet separating unit 152 directs sheets to the second post-processing unit 153 or the first post-processing unit 154. The second post-processing unit 153 performs post-processing such as saddle stapling and saddle folding. The first post-processing unit 154 performs post-processing such as paper discharge from normal print processing, sorting of sheets, and stapling of an end of a sheet bundle.

The sheet post-processing apparatus 150 conveys the sheets to the second post-processing unit 153 or the first post-processing unit 154 and applies the post-processing to the sheets according to an input instruction through the operation panel by the user or a print instruction from the external apparatus such as the PC connected to the MFP 100 via the LAN.

The first post-processing unit 154 includes a branching member 155, a roof tray 156, a processing tray 157, a stapler 158, a waiting tray 159, and a paper discharge tray 160.

The branching member 155 switches a conveying path according to selected post-processing. Normal print sheets are sequentially stacked on the roof tray 156. A sheet bundle to be stapled is placed on the processing tray 157. The stapler 158 staples the sheet bundle. The waiting tray 159 temporarily accumulates sheets, which are conveyed thereto, in order to secure time necessary for stapling and sheet carry-out. The stapled or sorted sheet bundle is stacked on the paper discharge tray 160.

The operation of the stapling is explained below.

When the stapling for the end of the sheet bundle is performed, the sheet separating unit 152 delivers the sheets to the first processing unit 154. In the first processing unit 154, the branching member 155 deflects the sheets in the downward direction and discharges the sheets to the waiting tray 159. The waiting tray 159 temporarily accumulates the sheets, which are sequentially conveyed thereto, to adjust a flow of sheet conveyance. When a predetermined number of sheets are accumulated in the waiting tray 159, the sheets are discharged to the processing tray 157. When a predetermined number of sheets are aligned and accumulated in the processing tray 157, the stapler 158 executes the stapling. A sheet bundle stapled by the stapler 158 is carried out to and stacked in the paper discharge tray 160.

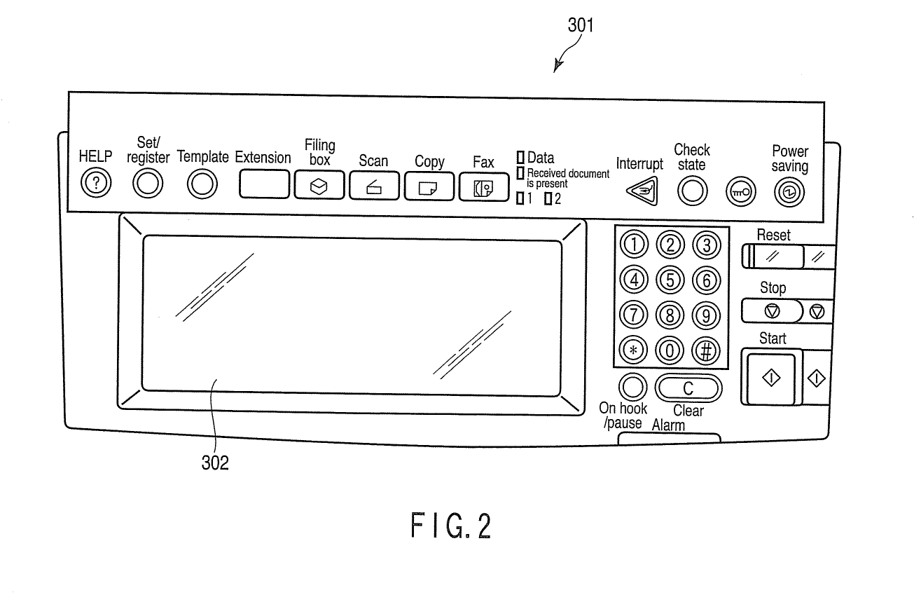

FIG. 2 is a diagram of a control panel 301 of the MFP 100. The user gives an instruction to the MFP 100 via the control panel 301. Hard keys such as function keys and a ten key and a display unit 302 are provided in the control panel 301. The user performs function inputs for copying, facsimile, and the like using the function keys and performs number input using the ten key. The display unit 302 displays a state of the MFP 100 and also functions as a touch panel.

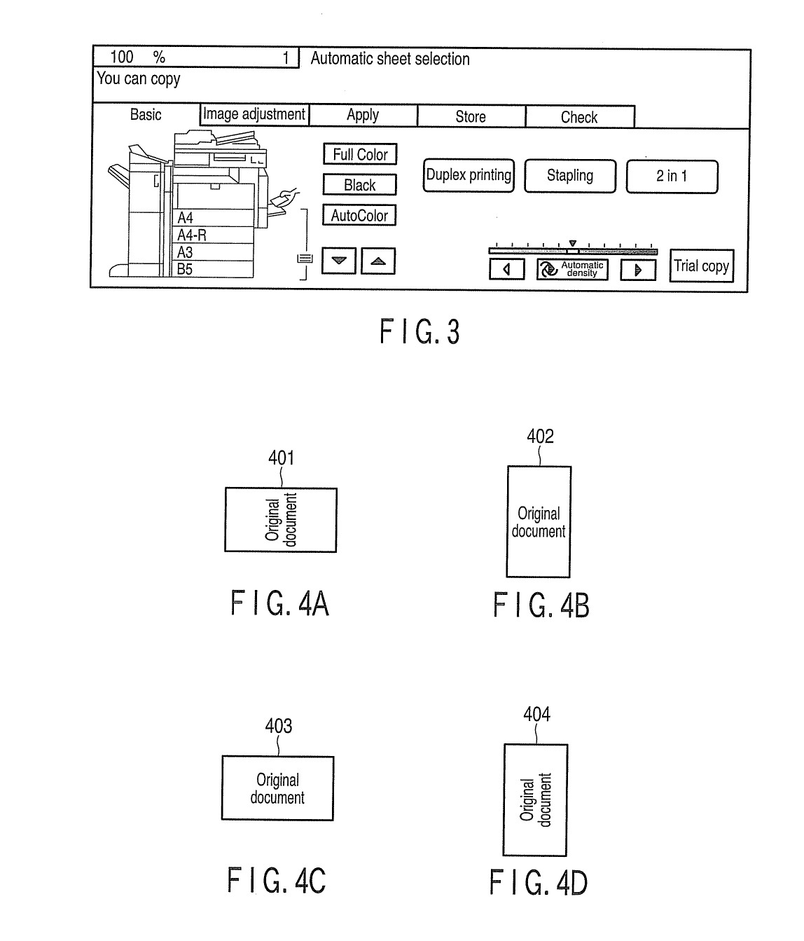

FIG. 3 is a diagram of a setting screen example of the display unit 302. The user can perform detailed setting for each of functions such as copying on the display unit 302. On a “basic” tab screen shown in FIG. 3, only frequently used settings are displayed for each of the functions. For example, as the frequently used settings, besides setting for cassettes (A4, A4-R, A3, and B5) and setting for colors (full color, black, and auto-color), buttons for selecting “duplex”, “2-in-1”, and “stapling” operations are displayed.

Operations executed when “duplex”, “2-in-1”, and “stapling” are selected are explained below. When “duplex” is selected, operation for performing the duplex printing from a one-side document is executed. When “2-in-1” is selected, a two-page document is reduced to a half and output as one page. When “stapling” is selected, the stapling is applied to one place at an upper left corner of a sheet bundle. Since processing can be designated only by button operation in this way, the user can easily realize a frequently used finish without performing complicated setting.

In the duplex, 2-in-1, and stapling settings, in some case, detailed setting is required. For example, in the duplex printing, there are plural setting items such as whether an original document is a one-side document or a both-side document. However, in this embodiment, the operations defined by the “basic” tab are treated. Therefore, a user requiring detailed setting performs the detailed setting from an “application” tab screen.

FIGS. 4A to 4D are diagrams of directions of original documents and directions of sentences designated by the user when the user sets the original documents on the document table 203. A main scanning direction of scanning of the original documents is an up-to-down direction in the figure and a sub-scanning direction of the scanning is a left-to-right direction in the figure.

In FIG. 4A, an original document 401 represents that the original document 401 is a portrait document and is placed sideways when the original document 401 is read. The portrait document is an original document in which a sentence can be correctly shown when the original document is arranged to be long in the vertical direction. “Placing the original document sideways” means that the original document is placed such that a side in the sub-scanning direction is long during scanning or paper feeding.

In FIG. 4B, an original document 402 represents that the original document 402 is a portrait document and is placed lengthwise when the original document 402 is read. “Placing the original document lengthwise” means that the original document is placed such that a side in the sub-scanning direction is short during scanning or paper feeding. In FIG. 4C, an original document 403 represents that the original document 403 is a landscape document and is placed sideways when the original document 403 is read. The landscape document is an original document in which a sentence is correctly shown when the original document is arranged to be long in the horizontal direction. In FIG. 4D, an original document 404 represents that the original document 404 is a landscape document and is placed lengthwise when the original document 404 is read.

Combinations of sentence directions (a portrait direction and a landscape direction) and document directions (lengthwise and sideways) are the four sets explained above. Further, sheets set in the sheet storing unit 112 are also placed lengthwise and sideways. Sheet directions in the sheet storing unit 112 are only these two sets (lengthwise and sideways). Therefore, combinations of the sentence directions, the document directions, and the sheet directions are eight sets (=4 sets×2 sets) in total.

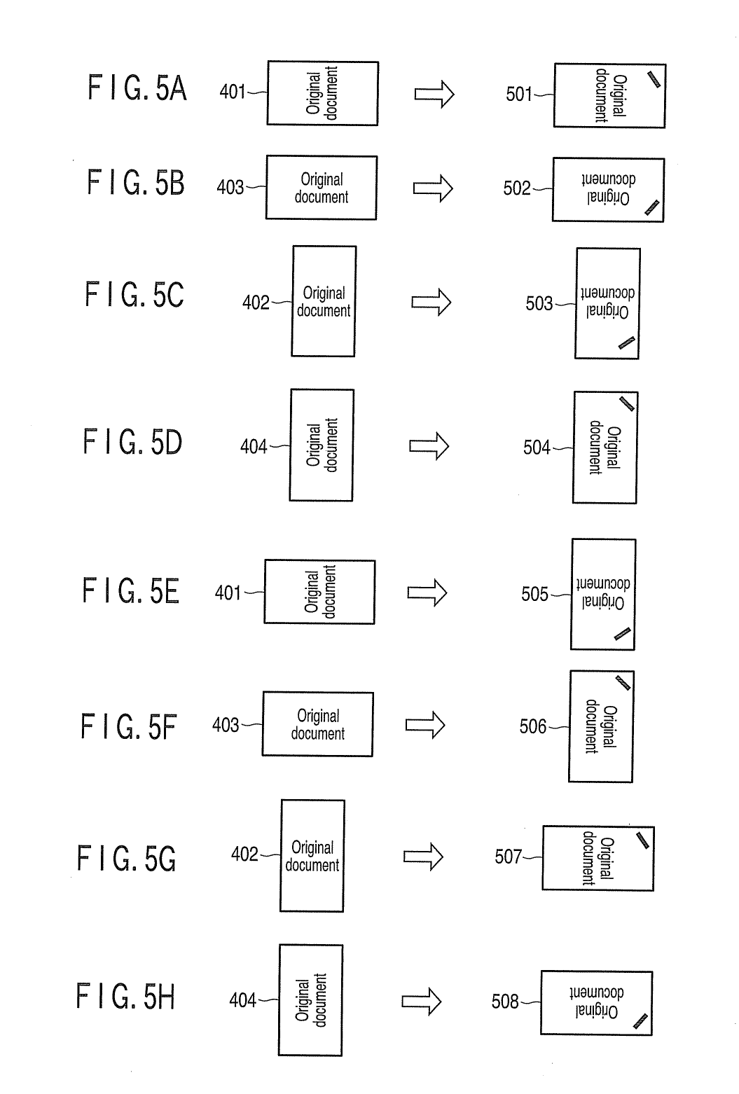

FIGS. 5A to 5H are diagrams of directions of original documents for stapling with respect to the combinations of the sentence directions, the document directions, and the sheet directions. The original documents 401 to 404 represent the combinations of the sentence directions and the document directions. On the other hand, sheets 501 to 508 represent sheet directions designated when the sheets 501 to 508 are sent to the sheet post-processing apparatus 150 for execution of the stapling.

For example, in FIG. 5A, the original document 401 is the portrait document and is placed sideways when the original document 401 is read. Since a sheet direction is sideways, the sheet 501 is sent to the sheet post-processing apparatus 150 in a sideways state. In this case, the sheet 501 needs to be printed as shown in FIG. 5A.

On the other hand, in FIG. 5E, as in FIG. 5A, the original document 401 is also a portrait document and is placed sideways when the original document 401 is read. However, a sheet direction is lengthwise. Therefore, the sheet 505 is sent to the sheet post-processing apparatus 150 in a lengthwise state. In this case, the sheet 505 needs to be printed as shown in FIG. 5E.

In FIGS. 5B and 5F, FIGS. 5C and 5G, and FIGS. 5D and 5H, sheet directions are different from each other.

In this embodiment, standard stapling finish is stapling at one place at an upper left corner with respect to a document direction. Because of a mechanism of the stapler 158 in the sheet post-processing apparatus 150, sheets 501 to 508 need to be sent to the sheet post-processing apparatus 150 such that stapling positions are set on the right sides of the sheets 501 to 508 shown in the figures.

Referring to FIGS. 5A to 5H, it is seen that, in order to realize the stapling according to this embodiment, images only have to be respectively formed as indicated by the sheets 501 to 508 with respect to combinations of sentence directions, document directions, and sheet directions.

Specifically, when document directions and sheet directions are the same (FIGS. 5A and 5B and FIGS. 5C and 5D), read images are rotated 180 degrees and printed. When document directions and sheet directions are different, sentence directions and the document directions are checked.

When a sentence direction is portrait and a document direction is sideways (FIG. 5E), a read image is rotated 90 degrees to the left and printed on a portrait sheet. When a sentence direction is portrait and a document direction is lengthwise (FIG. 5G), a read image is rotated 90 degrees to the right and printed on a landscape sheet.

When a document direction is landscape and a document direction is sideways (FIG. 5F), a read image is rotated 90 degrees to the right and printed on a portrait sheet. When a sentence direction is landscape and a document direction is lengthwise (FIG. 5H), a read image is rotated 90 degrees to the left and printed on a landscape sheet.

In this way, in the stapling, a printing method depends on a combination of a sentence direction, a document direction, and a sheet direction.

The operation of the duplex printing is explained below.

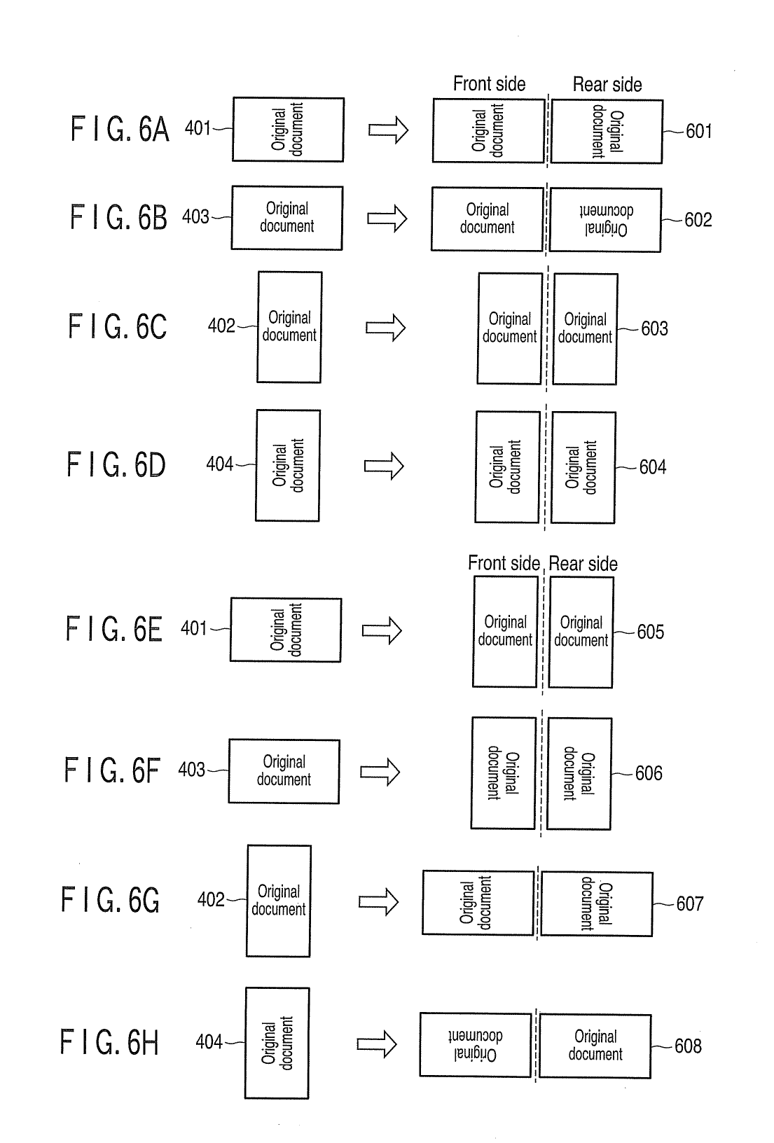

FIGS. 6A to 6H are diagrams of directions of original documents for the duplex printing with respect to combinations of sentence directions, document directions, and sheet directions. The original documents 401 to 404 represent the combinations of the sentence directions and the document directions. Sheets 601 to 608 represent results obtained by performing the duplex printing.

In the sheets 601 to 608 shown in the figure, the left side represents printing results on front sides and the right side represents printing results on rear sides. A state in which sheets are superimposed symmetrically along a dotted line in the center represents a sheet actually subjected to the duplex printing.

For example, in FIG. 6A, the original document 401 is a portrait document and is placed sideways when the original document 401 is read. After the front side of the sheet 601 is printed in a sideways state, a traveling direction of the sheet is reversed and the front and rear of the sheet 601 is reversed in the reversal path 122. The sheet 601 is conveyed to the image forming unit 113 via the duplex conveying path 123 and the rear side of the sheet is printed. The front and rear sides of the sheet 601 have to be printed as shown in FIG. 6A.

On the other hand, in FIG. 6E, as in FIG. 6A, the original document 401 is a portrait document and is placed sideways when the original document 401 is read. However, a sheet direction is lengthwise. Therefore, the sheet 605 is sent to the image forming unit 113 in a lengthwise state and printing is executed. Thereafter, a traveling direction of the sheet 605 is reversed and the front and rear of the sheet 605 reversed in the reversal path 122. The sheet 605 is conveyed to the image forming unit 113 again via the duplex conveying path 123 and the rear side of the sheet 605 is printed. The front and rear sides of the sheet 605 have to be printed as shown in FIG. 6E.

In FIGS. 6B and 6F, FIGS. 6C and 6G, and FIGS. 6D and 6H, sheet directions are also different.

Referring to FIGS. 6A to 6H, it is seen that, in order to realize the duplex printing according to this embodiment, images only have to be respectively formed as indicated by sheets 601 to 608 with respect to combinations of document directions and sheet directions.

Specifically, when both a document direction and a sheet direction are sideways (FIGS. 6A and 6B), during front side printing, a read image is directly printed and, during rear side printing, the image is rotated 180 degrees and printed. When both a document direction and a sheet direction are lengthwise (FIGS. 6C and 6D), a read image is directly printed both during front side printing and during rear side printing.

When a document direction is sideways and a sheet direction is lengthwise (FIGS. 6E and 6F), a read image is rotated 90 degrees to the right and printed both during front side printing and during rear side printing. When a document direction is lengthwise and a sheet direction is sideways (FIGS. 6G and 6H), during front side printing, a read image is rotated 90 degrees to the left and printed and, during rear side printing, the read image is rotated 90 degrees to the right and printed.

In this way, in the duplex printing, a printing method depends on a combination of a document direction and a sheet direction without depending on a sentence direction.

The operation of the 2-in-1 printing is explained below.

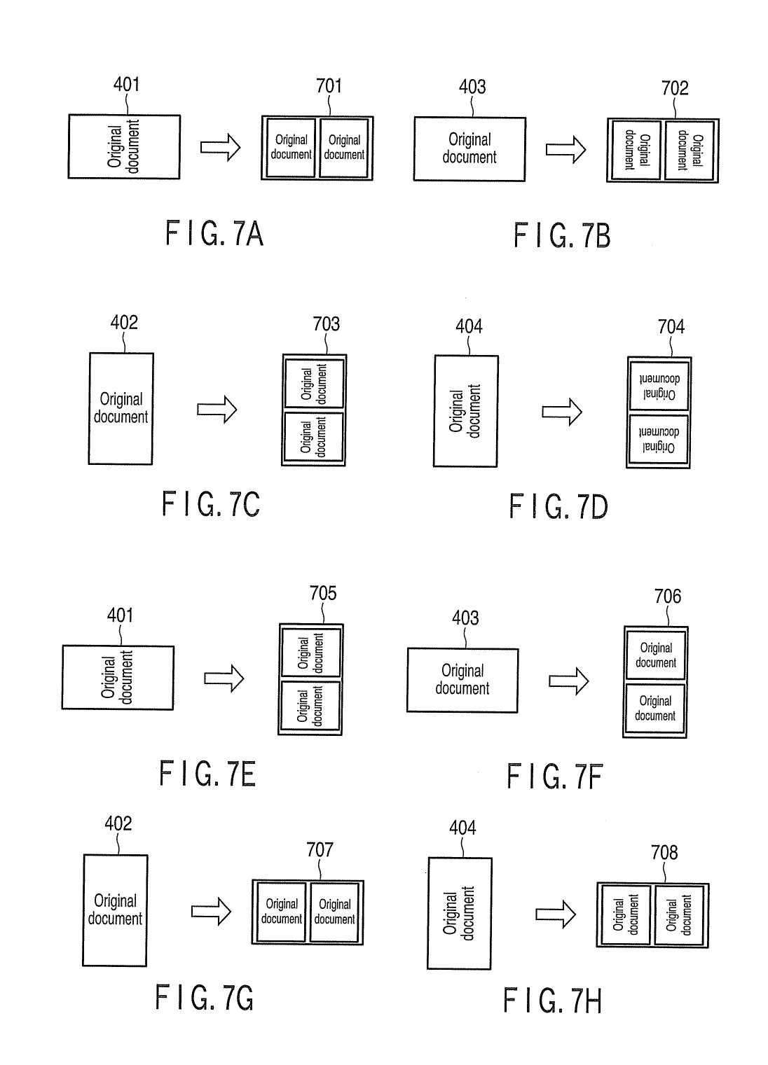

FIGS. 7A to 7H are diagrams of directions of original documents for the 2-in-1 printing with respect to combinations of sentence directions, document directions, and sheet directions. The original documents 401 to 404 represent the combinations of the sentence directions and the document directions. On the other hand, sheets 701 to 708 represent results obtained by performing the 2-in-1 printing.

For example, in FIG. 7A, the original document 401 is a portrait document and is placed sideways when the original document 401 is read. Since a sheet direction of the sheet 701 is sideways, a read image is rotated 90 degrees to the right and reduced and a pair of the reduced images are joined and printed on the sheet 701.

On the other hand, in FIG. 7E, as in FIG. 7A, the original document 401 is a portrait document and is placed sideways when the original document 401 is read.

However, a sheet direction of the sheet 705 is lengthwise. Therefore, a read image is directly reduced and a pair of the reduced images are joint and printed on the sheet 701.

In FIGS. 7B and 7F, FIGS. 7C and 7G, and FIGS. 7D and 7H, sheet directions are also different.

Referring to FIGS. 7A to 7H, it is seen that, in order to realize the 2-in-1 printing according to this embodiment, images only have to be respectively formed as indicated by the sheets 701 to 708 with respect to combinations of document directions and sheet directions.

Specifically, when both a document direction and a sheet direction are sideways (FIGS. 7A and 7B), a read image is rotated 90 degrees to the right and reduced and a pair of the reduced images are joined and printed. When both a document direction and a sheet direction are lengthwise (FIGS. 7C and 7D), a read image is rotated 90 degrees to the left and reduced and a pair of the reduced images are joint and printed. When a document direction and a sheet direction are different (FIGS. 7E, 7F, 7G, and 7H), a read image is directly reduced without being rotated and a pair of the reduced images are joined and printed.

In this way, in the 2-in-1 printing, a printing method depends on a combination of a document direction and a sheet direction without depending on a sentence direction.

As explained above, concerning the standard duplex, stapling, and 2-in-1 setting, if a document direction, a sentence direction, and a sheet direction are determined, a control method is uniquely determined. The same holds true when duplex printing, stapling, and 2-in-1 printing are combined. When the duplex printing and the 2-in-1 printing are combined, for example, the control method explained above only has to be executed in order of, for example, the 2-in-1 printing and the duplex printing. When the duplex printing and the stapling are combined or when the 2-in-1 printing and the stapling are combined, as explained with reference to FIG. 5, it is sufficient to control printing such that a stapling position is in the predetermined position and send a sheet to the sheet post-processing apparatus 150.

Therefore, if a document direction, a sentence direction, and a sheet direction are automatically detected, the user can obtain a desired output without inputting a document direction and a sentence direction and inputting details of finish setting as in the past.

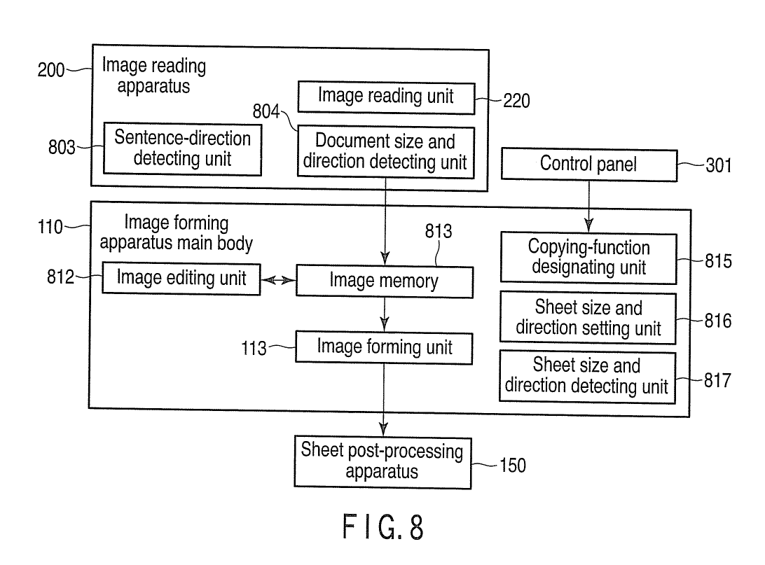

FIG. 8 is a diagram of blocks for controlling image forming operation of the MFP 100 according to this embodiment.

The image reading apparatus 200 includes an image reading unit 220, a sentence-direction detecting unit 803, and a document size and direction detecting unit 804. The image reading unit 220 executes processing such as shading correction on an electric signal photoelectrically converted by a CCD and outputs image data (an image signal).

The sentence-direction detecting unit 803 detects a sentence direction using a layout analysis technique for an image. The sentence-direction detecting unit 803 divides image data into belt-like areas in vertical and horizontal two directions and counts the number of pixels present in the respective belt-like areas. The sentence-direction detecting unit 803 recognizes a character direction from a difference between the number of pixels in the belt-like area in the vertical direction and the number of pixels in the belt-like area in the horizontal direction and detects a direction of a sentence.

When an original document is set on the document table 203, the document size and direction detecting unit 804 detects an image size and an image direction using an optical sensor. When the document feeder 205 is used, the document size and direction detecting unit 804 detects paper feeding direction size from paper passing time, detects paper width from a width detection sensor (an optical sensor), and detects a document size and a document direction from these kinds of information. The document size and direction detecting unit 804 may specify an image size and an image direction from a read image.

The image forming apparatus main body 110 includes an image editing unit 812, an image memory 813, the image forming unit 113, a copying-function designating unit 815, a sheet size and direction setting unit 816, and a sheet size and direction detecting unit 817.

The copying-function designating unit 815 acquires information concerning which of the copying functions “duplex”, “2-in-1”, and “stapling” is selected on the “basic” tab screen of the control panel 301. Not only one copying function but also plural copying functions can be collectively selected. The sheet size and direction setting unit 816 acquires a sheet size and a sheet direction designated by the user on the control panel 301. The sheet size and direction detecting unit 817 automatically acquires a sheet size and a sheet direction for each of the cassettes of the sheet storing unit 112 selected on the control panel 301. For example, the sheet size and direction detecting unit 817 detects a sheet size and a sheet direction from a position of a guide that holds sheets, which are stored in the cassette, from sides such that the sheets are stabilized.

The image editing unit 812 applies processing such as rotation or reduction to the read image data according to the selected copying function and the detected sentence direction, document direction, and sheet direction and edits an image for exposing and scanning a transfer drum surface. The image memory 813 is a buffer memory that stores the image data processed by the image reading apparatus 200 and the image editing unit 812. The image forming unit 113 forms a toner image on the transfer drum surface and transfers the toner image onto a sheet. The image forming unit 113 delivers the sheet having the toner image transferred thereon to the sheet post-processing apparatus 150.

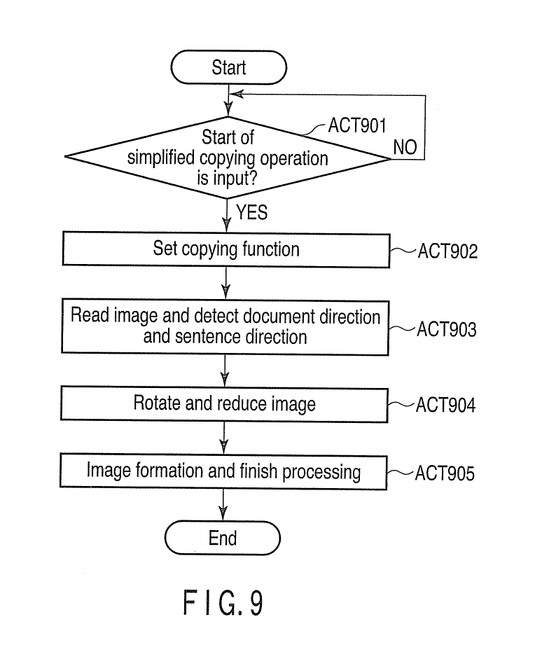

FIG. 9 is a flowchart of schematic copying operation in the image forming apparatus according to this embodiment.

A flow of control is explained with reference to the flowchart shown in FIG. 9. In Act 901, the image forming apparatus stays on standby until simplified copying is selected from the “basic” tab screen of the control panel 301. If the simplified copying is selected in Act 901 (Yes in Act 901), in Act 902, the copying-function designating unit 815 decides presence or absence of setting of duplex printing, stapling, or 2-in-1 printing.

When reading of an image is started according to operation by the user, in Act 903, the document-direction detecting unit 803 and the document size and direction detecting unit 804 specify a document direction and a sentence direction. In Act 904, the image editing unit 812 decides a combination of rotation and reduction of the image from setting information of duplex printing, stapling, and 2-in-1 printing and the document direction, the sentence direction, and a sheet direction and performs image editing operation. Since the image editing method is already explained with reference to FIGS. 5A to 5H, FIGS. 6A to 6H and FIGS. 7A to 7H, redundant explanation of the method is omitted.

In Act 905, the image forming unit 113 performs image forming operation on the basis of edited image data and executes processing such as duplex printing or stapling according to the setting.

As explained above, according to this embodiment, the user can surely perform a desired copying function without performing complicated designation of a document direction and a sentence direction and without performing detailed setting of a copying function.

The present invention is explained above with reference to the specific embodiment. However, it would be obvious to those skilled in the art that various alterations and modifications can be made without departing from the spirit and the scope of the present invention.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image forming apparatus comprising:
an image reading unit configured to read a document image;
a document-direction detecting unit configured to detect a document direction representing whether a sub-scanning direction in reading the document image is a short side direction or a long side direction of an original document;
a copying-function designating unit configured to designate, as a copying function, a form for copying the document image on a sheet;
an editing unit configured to edit the read document image as an image corresponding to the designated copying function;
a copying unit configured to copy the edited image on the sheet; and
a sheet-direction acquiring unit configured to acquire a sheet direction representing whether a conveying direction of the sheet conveyed to the copying unit to copy the image is the short side direction or the long side direction of the sheet, wherein
the editing unit executes processing including rotation or reduction on the document image on the basis of the document direction, the sheet direction, and the designated copying function.

2. The apparatus according to claim 1, wherein the sheet-direction acquiring unit acquires the sheet direction by detecting a storage state of the sheet.

3. The apparatus according to claim 1, wherein the designation of the copying function includes at least designation of duplex printing and designation of 2-in-1 printing.

4. The apparatus according to claim 3, wherein, when the designation of the copying function is the designation of two functions of the duplex printing and the 2-in-1 printing, the copying unit executes the 2-in-1 printing first and subsequently executes the duplex printing.

5. The apparatus according to claim 3, wherein
when the designation of the copying function is the designation of the duplex printing, the editing unit executes processing including rotation on the document image, and
when the designation of the copying function is the designation of the 2-in-1 printing, the editing unit executes processing including rotation and processing including reduction on the document image.

6. The apparatus according to claim 2, wherein the designation of the copying function includes at least designation of duplex printing and designation of 2-in-1 printing.

7. The apparatus according to claim 6, wherein, when the designation of the copying function is the designation of two functions of the duplex printing and the 2-in-1 printing, the copying unit executes the 2-in-1 printing first and subsequently executes the duplex printing.

8. The apparatus according to claim 6, wherein
when the designation of the copying function is the designation of the duplex printing, the editing unit executes processing including rotation on the document image, and
when the designation of the copying function is the designation of the 2-in-1 printing, the editing unit executes processing including rotation and processing including reduction on the document image.

9. An image forming apparatus comprising:
an image reading unit configured to read a document image;
a sentence-direction detecting unit configured to detect a sentence direction indicating whether an original document is a portrait document or a landscape document;
a document-direction detecting unit configured to detect a document direction representing whether a sub-scanning direction in reading the document image is a short side direction or a long side direction of the original document;
a copying-function designating unit configured to designate, as a copying function, a form for copying the document image on a sheet and collectively finishing plural sheets;
an editing unit configured to edit the read document image as an image corresponding to the designated copying function;
a copying unit configured to copy the edited image on the sheet;
a sheet-direction acquiring unit configured to acquire a sheet direction representing whether a conveying direction of the sheet conveyed to the copying unit to copy the image is the short side direction or the long side direction of the sheet; and
an output unit configured to convey the copied sheet to a finishing unit to finish the sheet, wherein
the editing unit executes processing including rotation on the document image on the basis of the sentence direction, the document direction, the sheet direction, and the designated copying function.

10. The apparatus according to claim 9, wherein the sheet-direction acquiring unit acquires the sheet direction by detecting a storage state of the sheet.

11. The apparatus according to claim 9, wherein, when the designation of the copying function is designation to apply stapling to the sheet, the editing unit executes processing including rotation on the document image such that a stapler provided in the finishing unit and the sheet conveyed from the output unit have a predetermined positional relation.

12. The apparatus according to claim 11, wherein the sheet-direction acquiring unit acquires the sheet direction by detecting a storage state of the sheet.

13. An image forming apparatus comprising:
an image reading unit configured to read a document image;
a sentence-direction detecting unit configured to detect a sentence direction indicating whether an original document is a portrait document or a landscape document;
a document-direction detecting unit configured to detect a document direction representing whether a sub-scanning direction in reading the document image is a short side direction or a long side direction of the original document;
a copying-function designating unit configured to designate, as a copying function, a form for copying the document image on a sheet and a form for collectively finishing copied plural sheets;
an editing unit configured to edit the read document image as an image corresponding to the designated copying function;
a copying unit configured to copy the edited image on the sheet;
a sheet-direction acquiring unit configured to acquire a sheet direction representing whether a conveying direction of the sheet conveyed to the copying unit to copy the image is the short side direction or the long side direction of the sheet; and
an output unit configured to convey the copied sheet to a finishing unit to finish the sheet, wherein
the editing unit executes processing including rotation or reduction on the document image on the basis of the sentence direction, the document direction, the sheet direction, and the designated copying function.

14. The apparatus according to claim 13, wherein the sheet-direction acquiring unit acquires the sheet direction by detecting a storage state of the sheet.

15. The apparatus according to claim 13, wherein, when the designation of the copying function is designation of two functions, which are duplex printing or 2-in-1 printing and stapling the sheet, the editing unit executes processing including rotation or reduction on the document image such that a stapler provided in the finishing unit and the sheet conveyed from the output unit have a predetermined positional relation.

16. The apparatus according to claim 15, wherein the sheet-direction acquiring unit acquires the sheet direction by detecting a storage state of the sheet.

17. An image forming method comprising:
reading a document image;
detecting a document direction representing whether a sub-scanning direction in reading the document image is a short side direction or a long side direction of an original document;
designating, as a copying function, a form for copying the document image on a sheet;
editing the read document image as an image corresponding to the designated copying function;
copying the edited image on the sheet; and
acquiring a sheet direction representing whether a conveying direction of the sheet conveyed to the copying unit to copy the image is the short side direction or the long side direction of the sheet, wherein
the editing the document image includes executing processing including rotation or reduction on the document image on the basis of the document direction, the sheet direction, and the designated copying function.

18. The method according to claim 17, wherein the acquiring the sheet direction includes acquiring the sheet direction by detecting a storage state of the sheet.

19. The method according to claim 17, wherein the designation of the copying function includes at least designation of duplex printing and designation of 2-in-1 printing.

20. The method according to claim 19, further comprising, when the designation of the copying function is the designation of two functions of the duplex printing and the 2-in-1 printing, executing the 2-in-1 printing first and subsequently executing the duplex printing.
